(19) United States
(12) Patent Application Publication
(10) Pub. No.: US 2012/0059498 A1
(43) Pub. Date: Mar. 8, 2012

(54) EXTRACTION OF COMMON AND UNIQUE COMPONENTS FROM PAIRS OF ARBITRARY SIGNALS

(75) Inventor: Gregory Berchin, Lake Saint Louis, MO (US)

(73) Assignee: AKITA BLUE, INC., Hollis, NH (US)

(21) Appl. No.: 13/319,009

(22) PCT Filed: May 11, 2010
(86) PCT No.: PCT/US10/34335

§ 371 Date: Nov. 4, 2011

(30) Foreign Application Priority Data
May 11, 2009 (US) 61177090

(51) Int. Cl. G06F 17/00

(52) U.S. Cl. 700/94

(57) ABSTRACT

A digital signal processing system and method transforms two time-domain signals into the frequency domain. Vector operations are performed upon the frequency-domain data by which signal components unique to one of the input signals are routed to one of the output signals, signal components unique to the other of the input signals are routed to another of the output signals, and signal components common to both signals are routed to a third and optionally to a fourth output signal. The frequency-domain output signals are then transformed back into the time-domain, forming an equivalent number of signals of output data. The vector operations are performed in a manner that preserves the overall information content of the input data.

### BACKGROUND

In many applications it is useful to determine the similarities and dissimilarities between signals. Two signals either have a lot in common (positively correlated) or they do not have a lot in common (uncorrelated or negatively correlated). Their amplitudes are either similar or different. Some obvious applications include audio signal decomposition and reconstruction when multiple audio channels must be separated or combined, noise or interference reduction when multiple versions of the same signal in different noise or interference environments are available, time-alignment or phase-alignment when multiple versions of the same signal delayed by different amounts of time or shifted by different phase angles are available. In general, these applications include any situation in which a measure of the degree to which two signals are similar and/or different is useful, or in which the actual signals representing those similarities or differences are useful.

Conventionally, these attributes are studied for full-bandwidth, or nearly so, signals.

### SUMMARY

A digital signal processing device in accordance with the present invention is capable of accepting two arbitrary input signals; applying an invertible transform (such as a Discrete Fourier Transform) to the data from each of the signals so that each may be represented as a set of two-dimensional vectors in the frequency domain; comparing the two signal vector sets on a frequency-by-frequency basis; mathematically resolving the two signal vectors at each frequency into three new vectors, one representing the signal content unique to the first of the input signals, another representing the signal content unique to the second of the input signals, and the last representing the signal content common to both input signals; applying the inverse transform (such as the Inverse Discrete Fourier Transform) to each of the three resolved vectors so that they represent time-domain data for the unique first, unique second, and common signals. This vector decomposition is performed in a manner that preserves information content, such that the vector sum of the two input vectors is exactly equivalent to the vector sum of the three derived output vectors, the first input vector is exactly equivalent to the vector sum of the unique first output vector and half the common output vector, and the second input vector is exactly equivalent to the vector sum of the unique second output vector and half the common output vector.

A digital signal processing device built in accordance with the present invention is optionally capable of further decomposing the aforementioned output vector sets into four output vector sets, the first representing the signal content unique to the first of the input signals, the second representing the signal content unique to the second of the input signals, the third representing the content common to, and having the same phase angle, in both input signals, and the fourth representing the content common to both input signals but having phase angles that are orthogonal to that of the third output signal; applying the inverse transform (such as the Inverse Discrete Fourier Transform) to each of the four resolved vector sets so that they represent time-domain data for the excess first, excess second, common inphase, and common quadrature signals, respectively. This vector decomposition is performed in a manner that preserves information content, such that the sum of the two input vectors is exactly equivalent to the sum of the two derived “excess” output vectors and twice the sum of the two derived “common” output vectors, the first input vector is exactly equivalent to the sum of the excess first output vector and the common inphase output vector and the common quadrature vector, and the second input vector is exactly equivalent to the sum of the excess second output vector and the common inphase output vector and the negative of the common quadrature vector.

Furthermore, this device is capable of performing these operations upon continuous streams of data by application of standard signal processing practices for transform-based filtering, with due regard for circular vs. linear convolution considerations, data tapering windows, overlap-and-add techniques, time-variant filtering, etc.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram of a digital signal processing system constructed in accordance with the present invention.

FIG. 2 is a generic graphical representation of the decomposition of the first input and second input vectors into the common, unique first, and unique second vectors.

FIG. 3 is a graphical representation of the decomposition of the first input and second input vectors into the common, unique first, and unique second vectors for the specific case in which the phase angle of the common vector is constrained to be halfway between the phase angles of the first input and second input vectors.

FIG. 4 is a graphical representation of the decomposition of the first input and second input vectors into the common, unique first, and unique second vectors for the specific case in which the phase angle of the common vector is constrained to be equal to the phase angle of the vector sum of the first input and second input vectors.

FIG. 5 is a graphical representation of the decomposition of the first input and second input vectors into the common, unique first, and unique second vectors for the specific case in which the common vector is equal to a constant “K” times the vector sum of the first input and second input vectors, the unique first vector is equal to the constant “1-K” times the first input vector, and the unique second vector is equal to the constant “1-K” times the second input vector.

FIG. 6 is a graphical representation of the decomposition of the first input and second input vectors into the common, unique first, and unique second vectors for the specific case in which the angle between the common vector and the unique first vector, and the angle between the common vector and the unique second vector, are both constrained to be 60°.

FIG. 7 is a graphical representation of the decomposition of the first input and second input vectors into the common, unique first, and unique second vectors for the specific case in which the unique first vector is constrained to be the negative of the unique second vector.

FIG. 8 is a graphical representation of the decomposition of the first input and second input vectors into the common, unique first, and unique second vectors for the specific case in which the shorter of the two input vectors is projected onto the longer.

FIG. 9 is a graphical representation of the decomposition of the first input and second input vectors into the common, unique first, and unique second vectors for the specific case in which the relative content of the common vector is artificially increased by moving a portion of the first input signal content to the second input signal, and vice-versa.

FIG. 10 is a graphical representation of the decomposition of the first input and second input vectors into the common, unique first, and unique second vectors for the specific case in which the relative content of the common vector is artificially decreased by scaling the common vector by a factor between zero and one prior to extracting the unique first and unique second vectors.

FIG. 11 is a graphical representation of the decomposition of the first input and second input vectors into the common inphase, common quadrature, excess first, and excess second vectors for the specific case in which the phase angle of the common inphase vector is constrained to be equal to the phase angle of the vector sum of the first input and second input vectors.

### DETAILED DESCRIPTION

While the invention has been shown and described with reference to a number of embodiments thereof, it will be recognized by those skilled in the art that various changes in form and detail may be made herein without departing from the spirit and scope of the invention as defined by the appended claims.

The present invention relates generally to the analysis of pairs of signals having arbitrary or unknown relation to one-another, in order to determine signal components that they share in-common and components that are unique to each. However, it may also be employed in connection with all manner of multichannel or multitrack signals, provided that at least some channels associated with such signals can be considered pairwise for analysis.

As used herein, the term “arbitrary time-domain signal” means a signal produced or captured by signal generation or acquisition devices such as: linear or angular motion, vibration, acceleration, velocity, position, or momentum sensors; distance, direction, angle, or orientation sensors; size, thickness, depth, volume, shape, geometry or configuration sensors; temperature, pressure, or force transducers; electromagnetic receivers; electric or magnetic sensors; particle detectors; frequency, periodicity, spectrum, phase, modulation or distortion detectors; noise or entropy detectors; mass, density, or chemical composition sensors; indicators of physical characteristics, such as hardness or roughness or thermal or electrical conductivity or hysteresis; reflectance, transmittance, absorptance, refringence, or polarization detectors; voltage, current, resistance, capacitance, inductance or impedance sensors; state-of-matter or phase-of-matter detectors; and the like; the pair consisting of a first input digital time-domain signal and a second input digital time-domain signal;

In an aspect utilizing arbitrary input signals, the invention relates to determination of common and unique signal components by comparing the two input signals in the frequency domain, and resolving the signal information, in a vector sense, into “unique first”, “common”, and “unique second” signal components or into “excess first”, “common inphase”, “common quadrature”, and “excess second” signal components. In this preferred aspect, the invention exploits an assumption that the similarities between two arbitrary input signals can be represented by the in-phase signal components that they share in common and, optionally, by the quadrature-phase signal components that they share in common, and that the dissimilarities between two arbitrary input signals can be represented by the signal components that they do not share in common.

In other situations, the invention can provide an indication of direction-of-arrival; if signal components that appear only in the first input signal are known to have arrived from one direction, and components that appear only in the second input signal are known to have arrived from another direction, then components that appear equally in both input signals can be extracted by the invention and deemed to have arrived from a direction “halfway in-between” those input directions, and components that appear unequally in both input signals can be extracted by the invention and deemed to have arrived from directions proportionately between the first and second input directions, as appropriate.

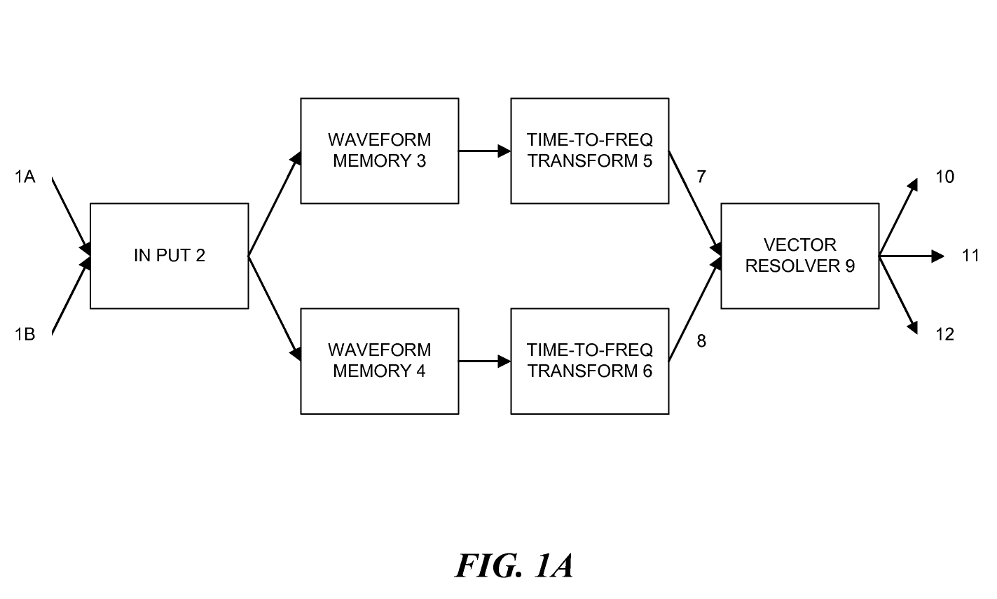

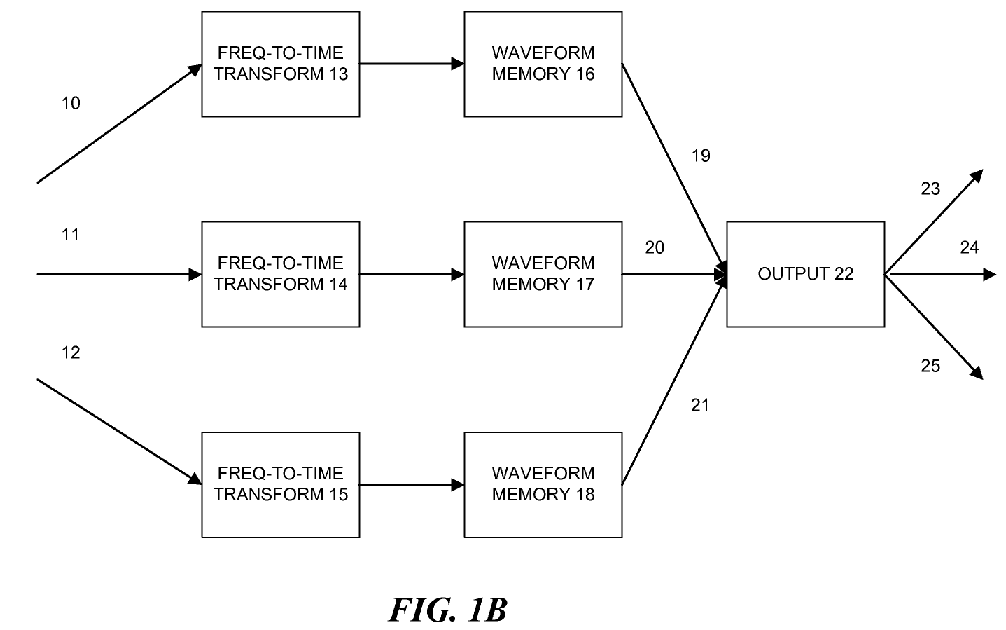

In one illustrative embodiment, a simplified block diagram of an implementation on a computer-based information handling system, such as a personal computer, that carries out the present invention is shown in FIG. 1. All of the elements of the personal computer apparatus to be described in the following are conventional and well known in the art and are described to illustrate the invention, and it is understood that other arrangements for computation in hardware, software, firmware, or any combination thereof may also be utilized in the present invention.

For example, in certain embodiments, a general-purpose central processing unit may be utilized to perform the digital signal processing functions. In other embodiments, the processing may be performed employing one or more dedicated processors. In further embodiments, a special purpose digital signal processor may be employed to perform computationally intensive processing of the digital signal, and with a general purpose central processing unit being used for any further processing and/or storing the processed signal representations in an electronic memory or other digital storage medium. In still further embodiments, the processing functionality may be implemented in whole or in part employing a dedicated computing device, hardware logic or finite state machine, which may be realized, for example, in an application-specific integrated circuit (ASIC), programmable logic device (PLD), field programmable gate array (FPGA), or the like.

Thus, while the use of multiple processors or processing devices is contemplated, it will be recognized that, for ease of exposition, the term “processor” is also intended to encompass a processing function, module, or subroutine, whether implemented in program or software logic or hardware logic, and reference to multiple processors also encompasses such multiple processing functions, modules, or subroutines sharing or implemented in common hardware.

Two digital time-domain input signals 1a and 1b are received at input 2 to the apparatus. These signals may be individual parts of a multichannel or multitrack signal, or they may be arbitrary or of unknown or ambiguous content. They may have been stored as digital data on some mass storage device such as a computer hard drive or digital magnetic tape, or they may have passed through some prior digital signal processing apparatus, or they may have been obtained directly from the output of analog-to-digital converters.

The digital data are passed to waveform memory 3 and 4 where the data are assigned and written sequentially to a number of memory positions corresponding to the number of points in transform computations 5 and 6.

Persons skilled in the art will recognize that pre- and/or post-processing of the data may be necessary, that some overlap between data points included in a given transform and data points included in the previous transform(s) is desirable, that application of data-tapering windows to the time-domain data, both before and after the output signal extraction is performed, is desirable to avoid edge-effects, that zeropadding of the input time-domain data may be necessary in order to avoid circular-convolution effects, and that this all represents standard signal processing practice for transform-domain filtering [4].

In the prototype preferred embodiment, signal parameters are identical in both input signals 1a and 1b: the sampling rate is 44100 Hz, integer input data are converted to floating-point, transforms are of length 32768 with an overlap of 8192 data points from one transform to the next, a raised-cosine input data tapering window of overall width 16384, centered on the splice between the “old” data and the “new” data, is used with 8192 extra zeropadded points on each end, and the computations are performed in the computer's central processing unit (CPU) and/or floating-point unit (FPU).

Transform computations 5 and 6 convert the blocks of data from the time domain to the frequency domain or, more generally, from the data domain to the transform domain. The transforms may be any of a variety of invertible transforms that can convert data from a one-dimensional data-domain representation to a two-dimensional transform-domain representation, typically but not necessarily the Discrete Fourier Transform that was implemented in the preferred embodiment. Other transforms that may be used include, but are not limited to, the Discrete Wavelet Transform, and invertible transforms of the general mathematical form:

X(k)=Σₙ₌₀^{N 1}x(n)[A cos(2πkn/N)+B sin(2πkn/N)]

(where A, B may be real, imaginary, complex, or zero), or equivalent thereto, including the Discrete Fourier Transform, Discrete Cosine Transform, Discrete Sine Transform, Discrete Hartley Transform, and Chirp-Z Transform; and various implementations thereof, including, but not limited to, direct computation using the defining equations, linear-algebra/matrix operations, convolution using FIR or IIR filter structures, polyphase filterbanks, subband filters, and especially the so-called “fast” algorithms such as the Fast Fourier Transform.

The type of transform, length of the transform, and amount of overlap between subsequent data sets are chosen according to standard signal processing practice as compromises between frequency resolution, ability to respond quickly to changes in signal characteristics, time-domain transient performance, and computational load.

Once in the transform domain, each transform bin 7 and 8 contains a two-dimensional value, interpreted in the conventional signal processing manner as a complex number, representing the signal content for the signal under consideration at the frequency corresponding to the bin. Each of these complex values can be expressed in the conventional signal processing manner as a vector quantity, in rectangular coordinates as real part and imaginary part, or equivalently in polar coordinates as magnitude and phase. The bin data 7 and 8 are passed to the vector resolver 9 that performs vector arithmetic upon them.

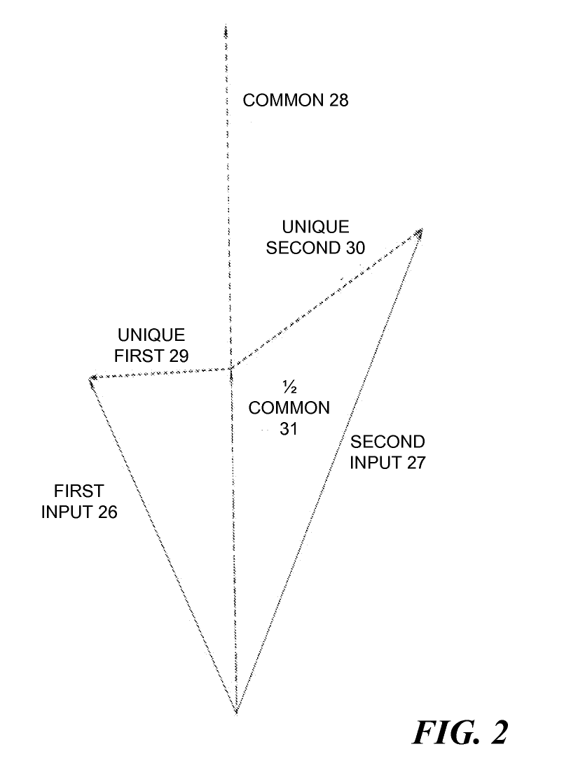

As indicated in FIG. 2, within resolver 9, in each transform bin the first input vector 26 and the second input vector 27 are decomposed into three new vectors 28, 29, and 30, nominally designated “common,” “unique first,” and “unique second,” respectively. The process starts with the creation of the common vector 28, which is conceptually a vector representing the signal content that the first and second signals have “in common”.

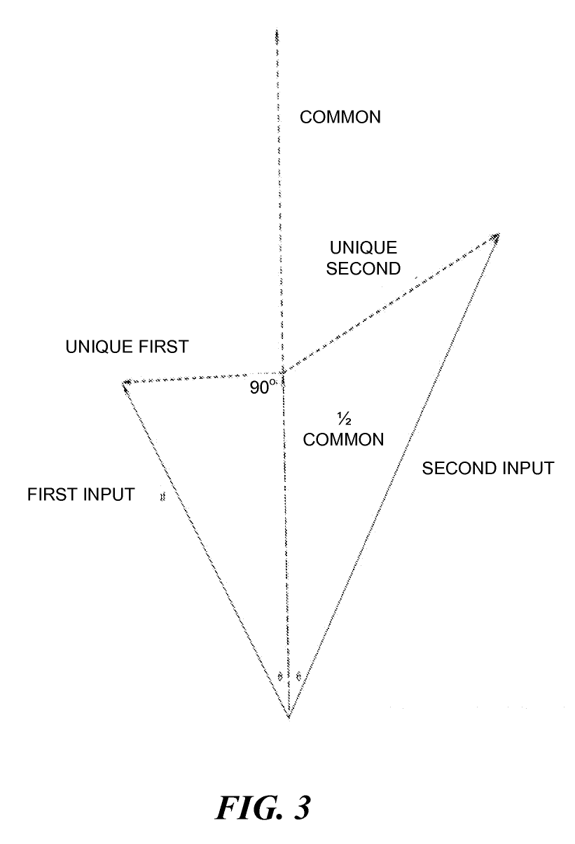

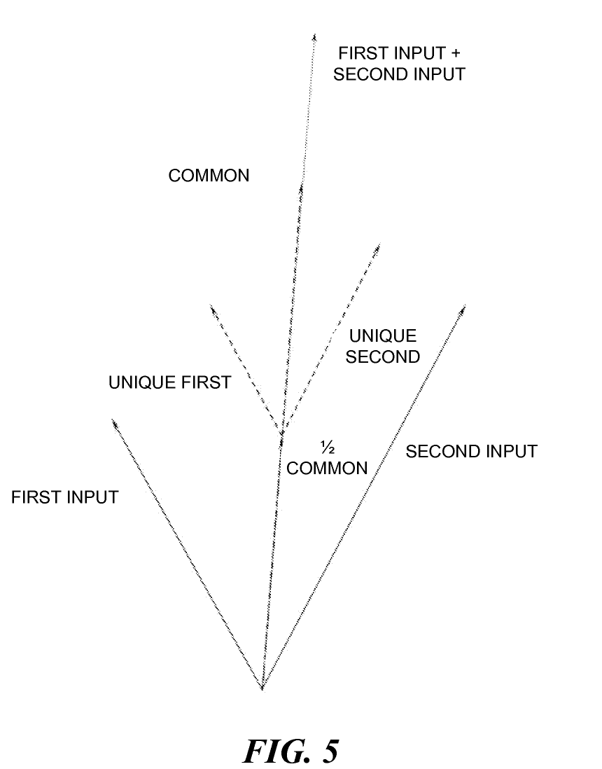

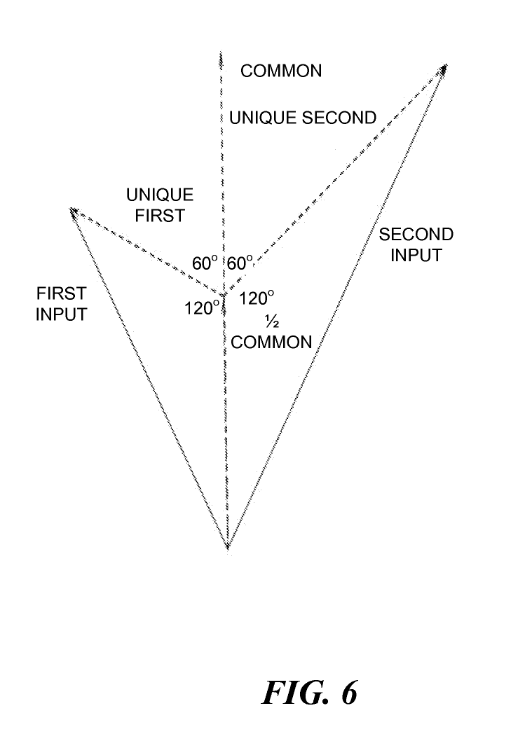

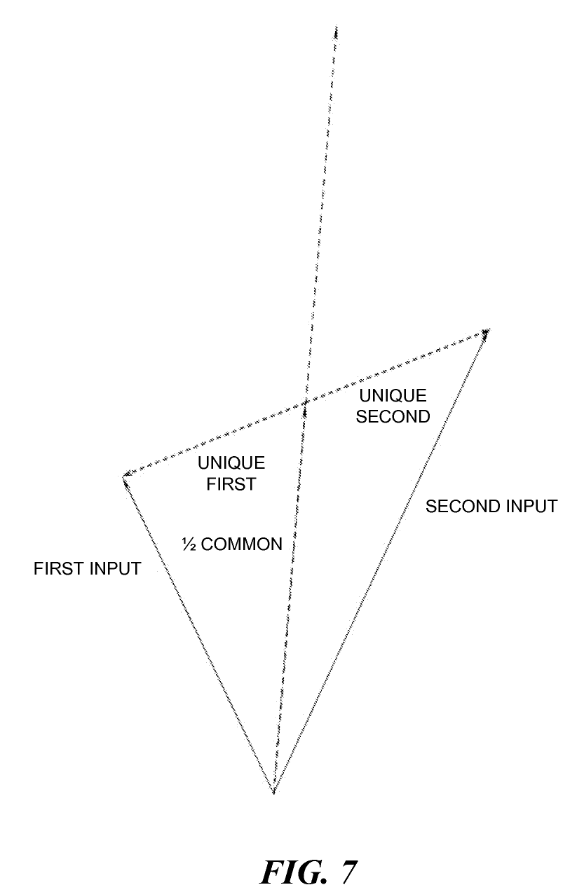

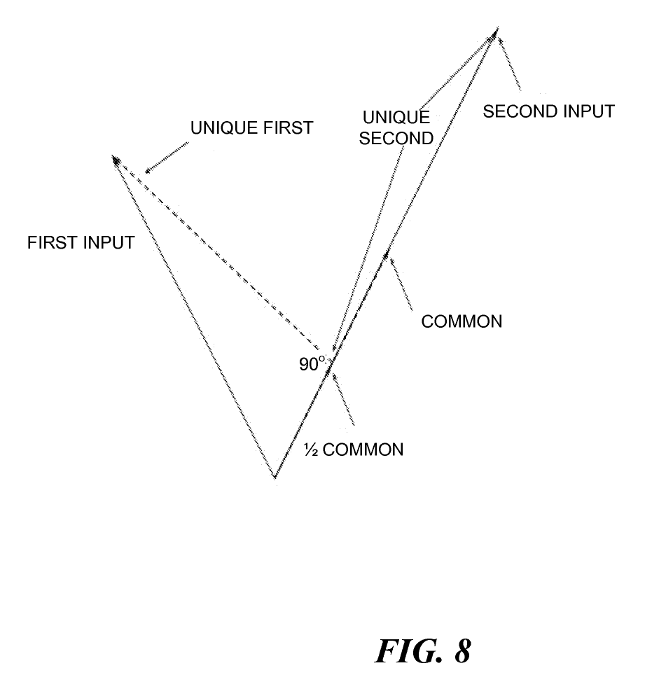

Methods for the computation of the common vector 28 include, but are not limited to, those shown in FIGS. 3 through 8. Because a unique definition for what two vectors have “in common” does not exist, persons skilled in the art will recognize that other mathematically viable schemes could be conceived.

In the prototype preferred embodiment, which is represented by FIGS. 2 and 3, the phase angle is defined to be the average of the phase angles of the first input signal and the second input signal, and the common magnitude is obtained by doubling (to account for the contribution from each of the two input signals) the perpendicular projection of the shorter of the two input signal vectors onto the unit vector in the direction of the common vector. In practice, the selection of vector resolution scheme might be based upon performance with specific signal content.

Once the common vector 28 has been created, the unique first vector 29 is computed as “first input minus ½-common” and the unique second vector 30 is computed as “second input minus ½-common”, using vector arithmetic. The unique first vector is conceptually the signal content that is unique to the first input signal, and the unique second vector is conceptually the signal content that is unique to the second input signal. In each transform bin, information is preserved because the vector sum of common 28, unique first 29, and unique second 30 is exactly equal to the vector sum of first input 26 and second input 27. Furthermore, the vector sum of ½-common 31 and unique first 29 is exactly equal to first input 26, and the vector sum of ½-common 31 and unique second 30 is exactly equal to second input 27.

This process is repeated for all of the transform bins, yielding three new complete transform blocks; designated unique first 10, common 11, and unique second 12, that are passed to the inverse transform computations 13, 14, and 15, respectively. The inverse transforms convert the blocks into the data domain, where they are stored in waveform memories 16, 17, and 18, and then, following standard signal processing practice, post-processed if necessary, aligned, windowed and combined with similar data from previous and subsequent blocks of time in a fashion appropriate for their original overlap, windowing, and zeropadding, to yield contiguous time-domain data streams 19, 20, and 21 in each of the three output (22) signals 23, 24, and 25, respectively.

In the prototype preferred embodiment, a 50% cosine-taper Tukey output data tapering window [5], with rectangle portion of width 16384 and cosine portion of width 16384, is applied to the outputs from the inverse transform computations. An overlap-and-add technique is utilized for reconstructing the time-domain data because this invention is, in its essence, a form of signal-dependent time-variant linear filtering, and overlap-and-add is superior to overlap-and-save when time-variant filters are used. The time data are converted from floating-point back to integer by appropriate means.

The resulting data streams 19, 20, and 21 may be monitored, stored as digital data, or passed through further signal processing, as desired.

The result of all of this vector manipulation is that identical signal components, in which the data are identical and in-phase in both input signals, are routed to the common output signal. Signal components that occur uniquely in the first or second input signal are routed exclusively to the unique first or unique second output signal, respectively. Signal components that are identical in both input signals, but out-of-phase, are treated as unique signal components and are not routed to the common output signal. Signal components that are combinations of the above are routed accordingly and proportionately to the output signals. Furthermore, since this process is repeated on a frequency-by-frequency basis in the transform domain, the invention has unprecedented ability to separate signal components by frequency as well as by magnitude and phase or real and imaginary part, and to route them to the output signals accordingly.

This technique may be varied in order to achieve some desired effects.

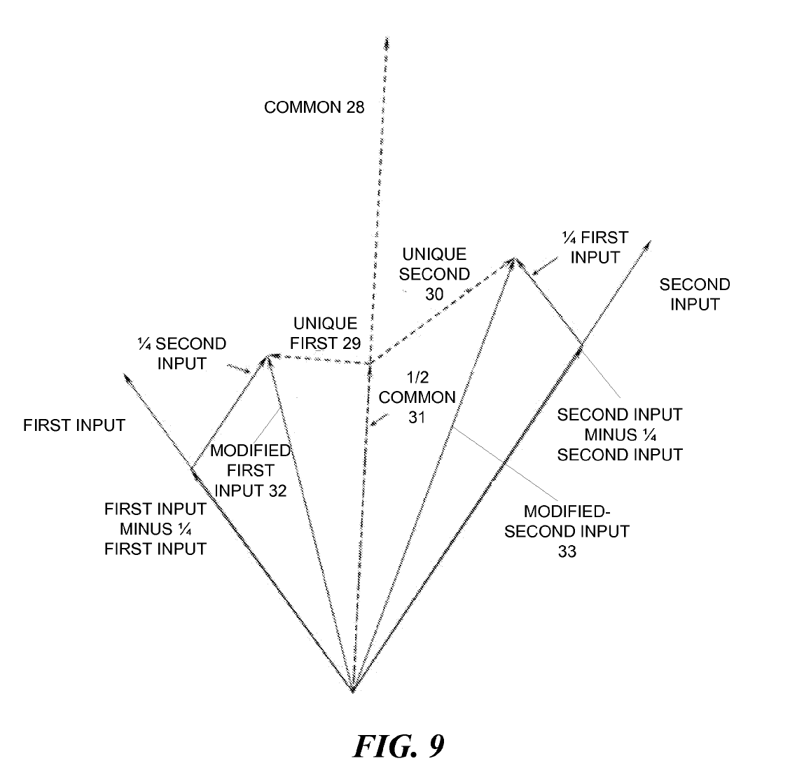

For example, if the first input and second input signals have very little in common, then the common signal may lack content. In such a situation it may be desirable to synthesize a pair of signals such that the common signal extracted from them has greater content. To accomplish this, some amount of material from the first input signal may be moved into the second input signal, and vice-versa, forming “modified-first input” 32 and “modified-second input” 33, as shown in FIG. 9; an example case identical to FIG. 3 except that ¼ of first input is added to second input, and ¼ of second input is added to first input. Then modified-first input 32 and modified-second input 33 are utilized by the vector resolver 9, in place of first input 26 and second input 27, and the process otherwise proceeds as described above.

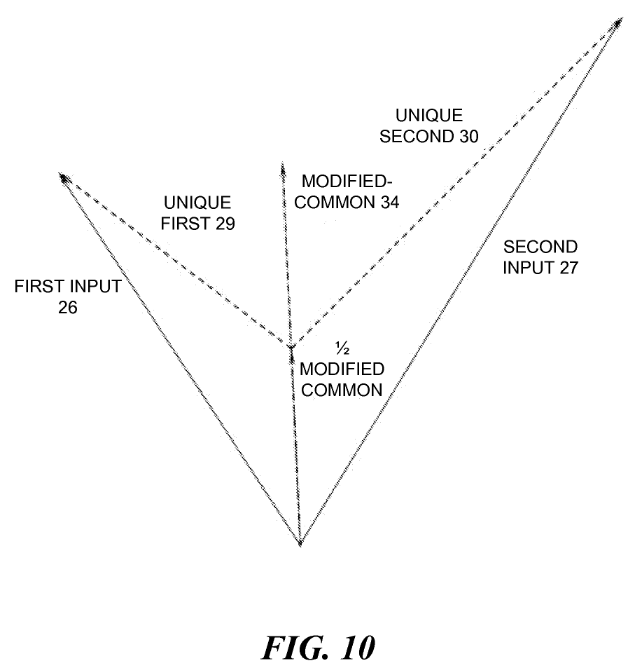

Conversely, if the first input and second input signals have too much in common, then the common signal may overwhelm the others. In such a situation is may be desirable to exclude some of the common content from the extracted common signal. To accomplish this, the magnitude of common vector 28, once created, may be multiplied by a scale-factor between zero and one, yielding “modified-common” 34, as indicated in FIG. 10; an example case identical to FIG. 3 except that the scale-factor is set to ½. The unique first vector 29 is then computed as “first input minus ½-modified-common” and the unique second vector 30 is computed as “second input minus ½-modified-common”. In each case, overall information content is still preserved, because in the former the vector sum of common 28, unique first 29, and unique second 30 is exactly equal to the vector sum of first input 26 and second input 27, and in the latter the vector sum of modified-common 34, unique first 29, and unique second 30 is exactly equal to the vector sum of first input 26 and second input 27.

The modifications shown in FIGS. 9 and 10 need not be applied uniformly at all frequencies. It is quite reasonable to expect that some signals may benefit from enhancement of common-signal content at some frequencies and reduction at others, with no modifications at the remainder.

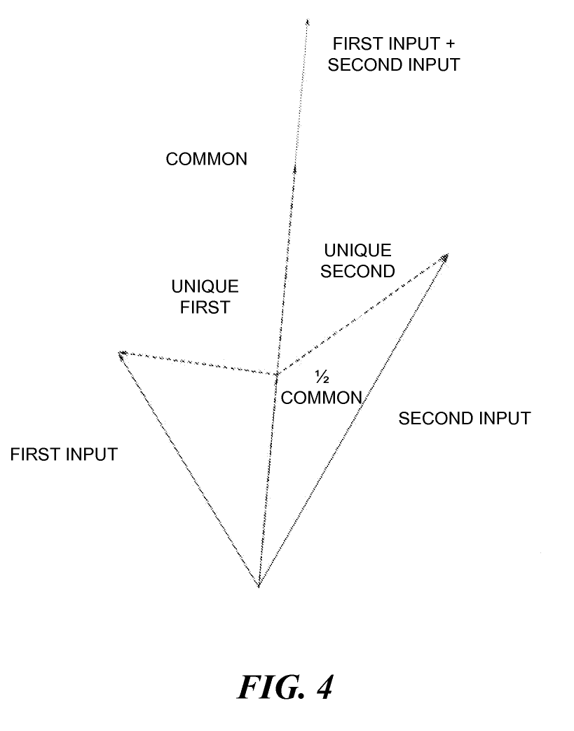

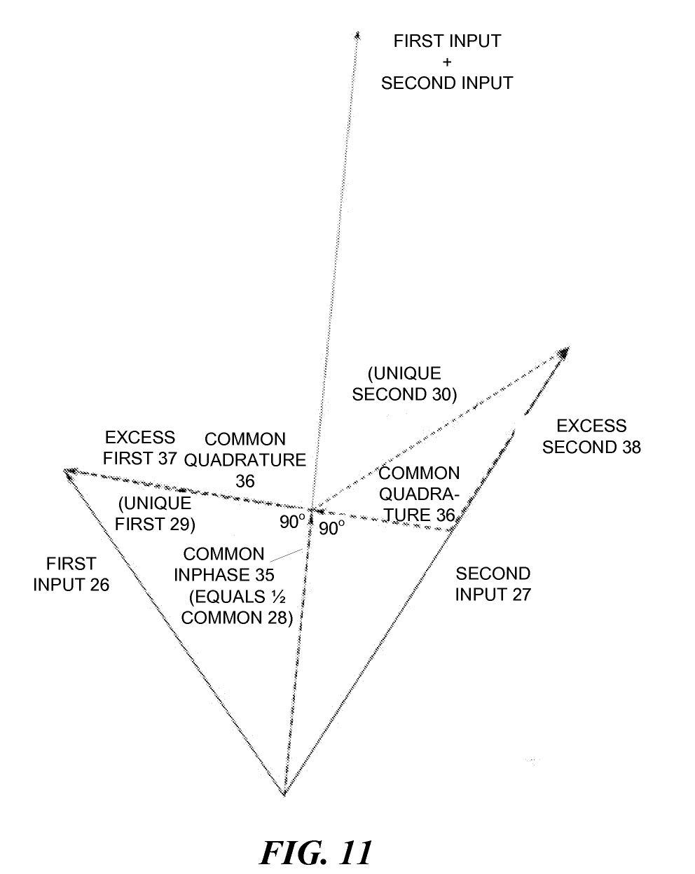

Finally, FIG. 11 shows a variant in which the each of the unique first 29/unique second 30 vectors from FIG. 4 is decomposed into two component vectors, at least one of which is orthogonal to the common 28 vector. These definitions result in four output vectors: common inphase 35 (equivalent to ½-common 28), common quadrature 36 (where the positive direction of the common quadrature 36 vector has been arbitrarily defined such that it lies on the same side of common 28 as first input 26), excess first 37, and excess second 38. This contrasts with the standard method of FIGS. 2 through 8, which only results in three output vectors: common 28, unique first 29, and unique second 30. The four vectors of FIG. 11 are derived in a manner similar to the previous three-vector cases; common quadrature 36 is equal to a projection of unique first 29, or the negative of a projection of unique second 30, whichever is shorter, excess first 37 is computed as “first input minus common inphase minus common quadrature” (and may, in some cases, be equal to zero), and excess second 38 is computed as “second input minus common inphase plus common quadrature” (and may, in some cases, be equal to zero). In each transform bin, information content can be preserved because the vector sum of twice common inphase 35, ±common quadrature 36, excess first 37, and excess second 38 is exactly equal to the vector sum of first input 26 and second input 27. Furthermore, the vector sum of common inphase 35, common quadrature 36, and excess first 37 is exactly equal to first input 26, and the vector sum of common inphase 35, the negative of common quadrature 36, and excess second 38 is exactly equal to second input 27.

The variant shown in FIG. 11 requires four inverse-transform operations to return to the time-domain instead of three, but allows access to both the common inphase and common quadrature time-domain data. The standard common 28, unique first 29, and unique second 30 signals can be obtained from common inphase 35, common quadrature 36, excess first 37, and excess second 38 as follows: common 28 equals twice common inphase 35, unique first 29 equals excess first 37 plus common quadrature 36, and unique second 30 equals excess second 38 minus common quadrature 36.

Persons skilled in the art will recognize that, although in the preferred embodiment the vector computations are performed in the computer's FPU, similar computations can be performed without explicit transcendental functions such as sines, cosines, and arctangents. Fixed-point arithmetic, function approximations, lookup tables, and/or vector manipulations such as cross-products, dot-products, and coordinate rotations, among others, are all recognized as viable means by which the vector quantities may be resolved.

Although the invention has been described with a certain degree of particularity, it should be recognized that elements thereof may be altered by persons skilled in the art without departing from the spirit and scope of the invention. One of the embodiments of the invention can be implemented as sets of instructions resident in the main memory of one or more computer-based information handling systems generally as described above. Until required by the computer system, the set of instructions may be stored in another computer readable memory, for example in a hard disk drive or in a removable memory such as an optical disk for utilization in a DVD-ROM or CD-ROM drive, a magnetic medium for utilization in a magnetic media drive, a magneto-optical disk for utilization in a magneto-optical drive, a floptical disk for utilization in a floptical drive, or a memory card for utilization in a card slot. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored electrically, magnetically, chemically, physically, optically, or holographically, so that the medium carries computer readable information.

It is understood that the invention is not confined to the particular embodiments set forth herein as illustrative, but embraces such modified forms thereof as come within the scope of the following claims.

### REFERENCES

All references cited are incorporated herein by reference in their entireties.
[1] “Surround Sound Past, Present, and Future”, Joseph Hull, Dolby Laboratories Inc., pp. 1-2.
[2] Hull, op cit., pp. 2-3.
[3] “Progress in 5-2-5 Matrix Systems”, David Griesinger, Lexicon, pp. 2-3.
[4] “Digital Signal Processing”, Alan V. Oppenheim and Ronald W. Schafer, Prentice-Hall, Inc., section 3.8.
[5] “On the use of Windows for Harmonic Analysis with the Discrete Fourier Transform”, Frederic J. Harris, PROCEEDINGS OF THE IEEE, VOL. 66, NO. 1, January 1978.

What is claimed is:

1. A digital signal processing method for creating multiple time-domain signals from a first arbitrary time-domain input signal and a second arbitrary time-domain input signal, the method comprising:
(a) applying a time-domain to frequency-domain transform to the first input signal and to the second input signal so that, at each of a plurality of frequencies, the first input signal and the second input signal are represented as a pair of vectors;
(b) mathematically resolving pairs of vectors generated in step (a) into three derived vectors: a unique first vector representing signal content unique to the first input signal, a unique second vector representing signal content unique to the second input signal, and a common vector representing signal content common to both the first input signal and the second input signal such that a vector sum of the unique first vector and one half of the common vector equals the first input vector, and a vector sum of the unique second vector and a remaining half of the common vector equals the second input vector; and
(c) applying a frequency-domain to time-domain transform to the derived vectors generated in step (b) to generate a unique first output time-domain signal, a unique second output time-domain signal, and a common output time-domain signal; the output signals, when further compared, analyzed, manipulated, and/or detected in another signal processing device, and/or rendered in human-perceptible form on an oscilloscope or other signal display device, together being representative of the degree to which the pair of input signals is similar or dissimilar, or indicative of the directions-of-arrival of components of the input signals.

2. The method of claim 1 wherein each of the unique first, unique second and common vectors is two-dimensional.

3. The method of claim 2 wherein, in step (a), the components of the vectors representing the first input and the second input signals represent real and imaginary values.

4. The method of claim 2 wherein, in step (a) the components of the vectors representing the first input and second input signals represent phase angle and magnitude and step (b) comprises for each pair of vectors, creating a common vector having a phase angle between the phase angles of the vector pair and having a magnitude equal to a multiple of the length of a perpendicular projection of a shorter vector of the vector pair onto a unit vector extending in a direction of the common vector.

5. The method of claim 4 wherein step (b) comprises for each pair of vectors, creating a common vector having a phase angle equal to an average of the phase angles of the vector pair and having a magnitude equal to twice the length of a perpendicular projection of a shorter vector of the vector pair onto a unit vector extending in a direction of the common vector.

6. The method of claim 5 wherein a first input vector represents the first input signal and a second input vector represents the second input signal, and step (b) comprises generating a unique first vector by subtracting one-half of the common vector from the first input vector, using vector arithmetic, and a unique second vector is generated by subtracting one-half of the common vector from the second input vector, using vector arithmetic.

7. The method of claim 4 wherein step (b) comprises for each pair of vectors, creating a common vector having a phase angle equal to a phase angle of a vector that is a sum of the two vectors that comprise the vector pair and having a magnitude equal to twice the length of a perpendicular projection of a shorter vector of the vector pair onto a unit vector extending in a direction of the common vector.

8. The method of claim 7 wherein a first input vector represents the first input signal and a second input vector represents the second input signal, and step (b) comprises generating a unique first vector by subtracting one-half of the common vector from the first input vector, using vector arithmetic, and a unique second vector is generated by subtracting one-half of the common vector from the second input vector, using vector arithmetic.

9. The method of claim 4 wherein step (b) comprises for each pair of vectors, creating a common vector having a phase angle equal to a phase angle of one of the vectors that comprise the vector pair and having a magnitude equal to twice the length of a perpendicular projection of a shorter vector of the vector pair onto a unit vector extending in a direction of the common vector.

10. The method of claim 9 wherein a first input vector represents the first input signal and a second input vector represents the second input signal, and step (b) comprises generating a unique first vector by subtracting one-half of the common vector from the first input vector, using vector arithmetic, and a unique second vector is generated by subtracting one-half of the common vector from the second input vector, using vector arithmetic.

11. The method of claim 1 wherein a first input vector represents the first input signal and a second input vector represents the second input signal and step (b) further comprises for at least some frequencies, adding a predetermined portion of the first input vector to the second input vector prior to creation of the common vector and adding a predetermined portion of the second input vector to the first input vector prior to creation of the common vector.

12. The method of claim 1 wherein step (b) further comprises for at least some frequencies, creating the common vector first and multiplying the common vector by a scale factor before creating the unique first and unique second vectors.

13. The method of claim 1 wherein, in step (a), a first input vector of the pair of vectors represents the first input signal and a second input vector represents the second input signal and wherein the method further comprises prior to step (c) further processing the unique first, unique second and common vectors to create a common inphase vector equal to one-half of the common vector, a common quadrature vector equal to the shorter of the unique first vector and a negative of the unique second vector, an excess first vector equal to the first input vector minus the common inphase vector minus the common quadrature vector and an excess second vector equal to the second input vector minus the common inphase vector plus the common quadrature vector.

14. The method of claim 1, wherein, in step (a), a first input vector of the pair of vectors represents the first input signal and a second input vector represents the second input signal and wherein step (b) comprises mathematically resolving pairs of vectors generated in step (a) so that the vector sum of the common, unique first, and unique second vectors is exactly equal to the vector sum of the first input and second input vectors, thereby preserving information content at each of the plurality of frequencies.

15. The method of claim 1, wherein, in step (a), a first input vector of the pair of vectors represents the first input signal and a second input vector represents the second input signal and wherein step (b) comprises mathematically resolving pairs of vectors generated in step (a) so that the vector sum of one half of the common vector and the unique first vector is exactly equal to the first input vector, and the vector sum of one half of the common vector and the unique second vector is exactly equal to second input vector, thereby preserving information content at each of the plurality of frequencies.

16. A digital signal processing device for creating multiple time-domain signals that may be compared, analyzed, manipulated, and/or detected in another signal processing device, and/or rendered in human-perceptible form on an oscilloscope or other signal display device, from a first digital arbitrary time-domain input signal and a second digital arbitrary time-domain input signal; the device comprising:
a memory;
a time-domain to frequency-domain transform that, responsive to the first input signal, generates at each of a plurality of frequencies, a first input vector that represents the first input signal and responsive to the second input signal, generates at each of the plurality of frequencies, a second input vector that represents the second input signal and that stores the first input vector and the second input vector in the memory;
a vector resolver that, at each of the plurality of frequencies retrieves a first input vector and a second input vector corresponding to that frequency from the memory and mathematically resolves a that first input vector and a that second input vector into three derived vectors: a unique first vector representing signal content unique to the first input signal, a unique second vector representing signal content unique to the second input signal, and a common vector representing signal content common to both the first input signal and the second input signal such that a vector sum of the unique first vector and one half of the common vector equals the first input vector, and a vector sum of the unique second vector and a remaining half of the common vector equals the second input vector; and
a frequency-domain to time-domain transform that, responsive to the unique first vectors generates a unique first output time-domain signal, responsive to the unique second vectors generates a unique second output time-domain signal and responsive to the common vectors generates a common output time-domain signal.

17. The device of claim 16 wherein each of the unique first, unique second and common vectors is two-dimensional.

18. The device of claim 17 wherein the time-domain to frequency-domain transform generates the first input vector and the second input vector with components representing real and imaginary values.

19. The device of claim 17 wherein the time-domain to frequency-domain transform generates the first input vector and the second input vector with components representing phase angle and magnitude and wherein the vector resolver, at each frequency, creates a common vector having a phase angle between the phase angles of the first input vector and the second input vector and having a magnitude equal to a multiple of the length of a perpendicular projection of a shorter vector of the first input vector and the second input vector onto a unit vector extending in a direction of the common vector.

20. The device of claim 19 wherein the vector resolver, at each frequency, creates a common vector having a phase angle equal to an average of the phase angles of the first input vector and the second input vector and having a magnitude equal to twice the length of a perpendicular projection of a shorter vector of the first input vector and the second input vector onto a unit vector extending in a direction of the common vector.

21. The device of claim 20 wherein the vector resolver generates a unique first vector by subtracting one-half of the common vector from the first input vector, using vector arithmetic, and a unique second vector is generated by subtracting one-half of the common vector from the second input vector, using vector arithmetic.

22. The device of claim 19 wherein the vector resolver, at each frequency, creates a common vector having a phase angle equal to a phase angle of a vector that is equal to a sum of the first input vector and the second input vector and having a magnitude equal to a multiple of the length of a perpendicular projection of a shorter vector of the first input vector and the second input vector onto a unit vector extending in a direction of the common vector.

23. The device of claim 22 wherein the vector resolver generates a unique first vector by subtracting one-half of the common vector from the first input vector, using vector arithmetic, and a unique second vector is generated by subtracting one-half of the common vector from the second input vector, using vector arithmetic.

24. The device of claim 19 wherein the vector resolver, at each frequency, creates a common vector having a phase angle equal to a phase angle of one of the first input vector and the second input vector and having a magnitude equal to a multiple of the length of a perpendicular projection of a shorter vector of the first input vector and the second input vector onto a unit vector extending in a direction of the common vector.

25. The device of claim 24 wherein the vector resolver generates a unique first vector by subtracting one-half of the common vector from the first input vector, using vector arithmetic, and a unique second vector is generated by subtracting one-half of the common vector from the second input vector, using vector arithmetic.

26. The device of claim 16 wherein the vector resolver, for at least some frequencies, adds a predetermined portion of the first input vector to the second input vector prior to creation of the common vector and adds a predetermined portion of the second input vector to the first input vector prior to creation of the common vector.

27. The device of claim 16 wherein the vector resolver, for at least some frequencies, creates the common vector first and multiplies the common vector by a scale factor before creating the unique first and unique second vectors.

28. The device of claim 16 wherein the vector resolver comprises a mechanism that further processes the unique first, unique second and common vectors to create a common inphase vector equal to one-half of the common vector, a common quadrature vector equal to the shorter of the unique first vector and a negative of the unique second vector, an excess first vector equal to the first input vector minus the common inphase vector minus the common quadrature vector and an excess second vector equal to the second input vector minus the common inphase vector plus the common quadrature vector.

29. The device of claim 16, wherein the vector resolver mathematically resolves the first input vector and the second input vector so that the vector sum of the common, unique first, and unique second vectors is exactly equal to the vector sum of the first input and second input vectors, thereby preserving information content at each of the plurality of frequencies.

30. The device of claim 16, wherein the vector resolver mathematically resolves the first input vector and the second input vector so that the vector sum of one half of the common vector and the unique first vector is exactly equal to the first input vector, and the vector sum of one half of the common vector and the unique second vector is exactly equal to second input vector, thereby preserving information content at each of the plurality of frequencies.
